(19) United States
(12) Patent Application Publication
(10) Pub. No.: US 2008/0116210 A1
(43) Pub. Date: May 22, 2008

(54) Heat-moderating baking pan

(76) Inventors: David E. Levy, Chicago, IL (US); Yury Galperin, Northbrook, IL (US); David E. Barnard, St. Paul, MN (US); Mark Cors, Columbus, WI (US); Rachel DeSmidt, Monona, WI (US); Nicholas Reback, Monona, WI (US)

Correspondence Address: MCDERMOTT, WILL & EMERY LLP, 227 WEST MONROE STREET, SUITE 4400, CHICAGO, IL, 60606-5096, US

(21) Appl. No.: 11/714,980

(22) Filed: Mar. 7, 2007

Related U.S. Application Data
(60) Provisional application No. 60/859,377, filed on Nov. 16, 2006.

(51) Int. Cl. A47J 37/01

(52) U.S. Cl. 220/573.1

(57) ABSTRACT

A baking pan is provided. The baking pan has a baking surface and a sidewall appending therefrom. The baking pan has a top surface and a bottom surface. The sidewall appends from the top surface and terminates in a terminal edge. The terminal edge of the sidewall is disposed at a position below the bottom surface of the baking surface.

### CROSS-REFERENCE TO RELATED APPLICATIONS

This application claims priority from U.S. Provisional Application No 60/859,377, which is incorporated herein by reference.

### TECHNICAL FIELD

The invention relates to baking pan, and more particularly, to a heat-moderating baking pan.

### BACKGROUND OF THE INVENTION

When baking food, it is commonly understood that “hot spots” often develop. Hot spots are generally caused by variations in heat distribution in ovens and at points of contact between a cooking surface (e.g., an oven rack) with a baking pan. Such occurrences are particularly pervasive in cooking environments that utilize conventional, non-convective ovens. This phenomenon may result in over-cooked, under-cooked food or unevenly cooked food.

Various baking pans and cooking methods have been employed in an attempt to prevent or minimize the effects of hot spots during cooking. For example, air-bake pans having fully-enclosed air pockets beneath the baking surface have been employed. The air pocket acts to transfer the heat to the baking surface. While such pans have met with some degree of success, there are significant shortcomings. Namely, air-bake pans often require increased baking time and result in baked goods that lack the familiar qualities derived from baking with traditional baking pans (e.g., crisped undersides, etc.). Furthermore, water and debris can become trapped in the air-pocket, resulting in a less hygienically favorable product. Additionally, air-bake pans can be expensive to manufacture because of the increased materials used in their construction. Accordingly, a need exists to provide a cost effective baking pan that provides a quick and more even distribution of heat across a baking surface and, thus more evenly baked resultant food.

The present invention is provided to solve the problems discussed above and other problems, and to provide advantages and aspects not provided by prior baking pans. A full discussion of the features and advantages of the present invention is deferred to the following detailed description, which proceeds with reference to the accompanying drawings.

### SUMMARY OF THE INVENTION

According to the present invention, a heat-moderating baking pan is provided. The baking pan has a baking surface and a sidewall appending therefrom. The baking pan has a top surface and a bottom surface. The sidewall appends from the baking surface and terminates in a terminal edge. The terminal edge of the sidewall is disposed at a position below the bottom surface of the baking surface

According to one aspect of the present invention, the baking pan includes a plurality of baking wells that extend downwardly from the baking surface to define a baking well bottom. According to such an embodiment, the terminal edge of the sidewall is disposed at a position below the baking well bottom.

According to another aspect of the present invention, the top surface of the baking surface includes either undulations or dimples disposed therein.

According to still another aspect of the present invention, the top surface of the baking surface is disposed below an apex of the sidewall.

According to still another aspect of the present invention, the baking pan has a first radius R₁ defining a first connection portion for connecting the baking surface to the sidewall and a second radius R₂ defining a second connection portion. The second connection portion is integrally connected to the first connection portion and is disposed at a point above the terminal end of the sidewall. The top most point of the second radius can define the apex of the sidewall. According to one embodiment of the invention, the first and second radii conform to the relationship R₂/R₁ being in the range of 0.5 to 8, and preferably in the range of approximately 0.01 to 2.

According to the invention, another embodiment of a heat-moderating baking pan is provided. The baking pan has a baking surface with a top surface and a bottom surface. A sidewall appends from the baking surface and terminates in a terminal edge. The terminal edge of the sidewall is disposed at a position below the bottom surface of the baking surface. The distance between the top surface and the terminal edge of the sidewall defines a cooking height Hₒ. The baking pan also includes at least one aperture in the sidewall. A portion of the aperture is contiguous with a portion of the terminal edge of the sidewall and has a predetermined height Hₐ and a predetermined width Wₐ. The cooking height Hₒ is in the range of approximately 0.25 to 3.0 inches and the aperture conforms to the relationship Hₐ/Wₐ being in the range of approximately 0.01 to 50.

According to one aspect of the invention, the sidewall extends downwardly and outwardly from the baking surface.

According to the invention, yet another embodiment of a heat-moderating baking pan is provided. The baking surface has a thickness Tₒ in the range of approximately 0.01 to 0.3 inches. A plurality of sidewall portions defining a sidewall append from the top surface, and each sidewall terminates in a terminal edge. The terminal edge of at least two of the sidewall members is disposed at a position below the bottom surface of the baking surface. The distance between top surface and the terminal edge of the at least two sidewalls defines a cooking height Hₒ in the range of approximately 0.25 to 3.0 inches. According to the embodiment, an aperture is formed in the at least two sidewalls, with each aperture being contiguous with a portion of the terminal edge of the respective sidewall. Furthermore, each of the apertures has a height Hₐ and a width Wₐ conforming to the relationship of Hₐ/Wₐ being in the range of approximately 0.01 to 2.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a heat-moderating baking pan according to one embodiment of the present invention;

FIG. 2 is a schematic view of a heat-moderating baking pan shown in FIG. 1, illustrating air flow beneath the baking surface of the baking pan;

FIG. 3 is a partial cross-sectional view of a heat-moderating baking pan shown in FIG. 1;

FIG. 4 is a side elevation view of a heat-moderating baking pan shown in FIG. 1;

FIG. 5 is a cross-sectional view of a heat-moderating baking pan shown in FIG. 4 as taken along the line 5-5;

FIG. 6 is a perspective view of another embodiment of a heat-moderating baking pan according to one embodiment of the present invention;

FIG. 7 is a side elevation view of a heat-moderating baking pan shown in FIG. 6;

FIG. 8 is a cross-sectional view of a heat-moderating baking pan shown in FIG. 6 as taken along the line 8-8;

FIG. 9 is a perspective view of another embodiment of a heat-moderating baking pan according to one embodiment of the present invention;

FIG. 10 is a perspective view of another embodiment of a heat-moderating baking pan according to one embodiment of the present invention;

FIG. 11 is a perspective view of another embodiment of a heat-moderating baking pan according to one embodiment of the present invention; and,

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

According to the present invention, a heat-moderating baking pan 1 is provided. As will be discussed below, according to one aspect of the invention, a bakeware structure is provided that elevates the baking surface 10 of the baking pan 1 above the top surface of a cooking surface (e.g., an oven cooking rack, grill, etc.). As a result, the baking pan 1 takes advantage of natural convection occurring in an oven environment by facilitating the improved circulation and capture of warmed air below the baking surface 10. Thus, a more even heat distribution across the baking surface 10 of the baking pan 1 can be altered by varying the distance between the baking surface 10 and the cooking surface. According to another aspect of the present invention, heat distribution is improved by providing venting in the baking pan 1 below the baking surface 10. As discussed below, it has been determined that the relative size and positioning of the venting can bear on the flow of warm air beneath the baking surface 10 of a baking pan 1 and thus distribution of heat.

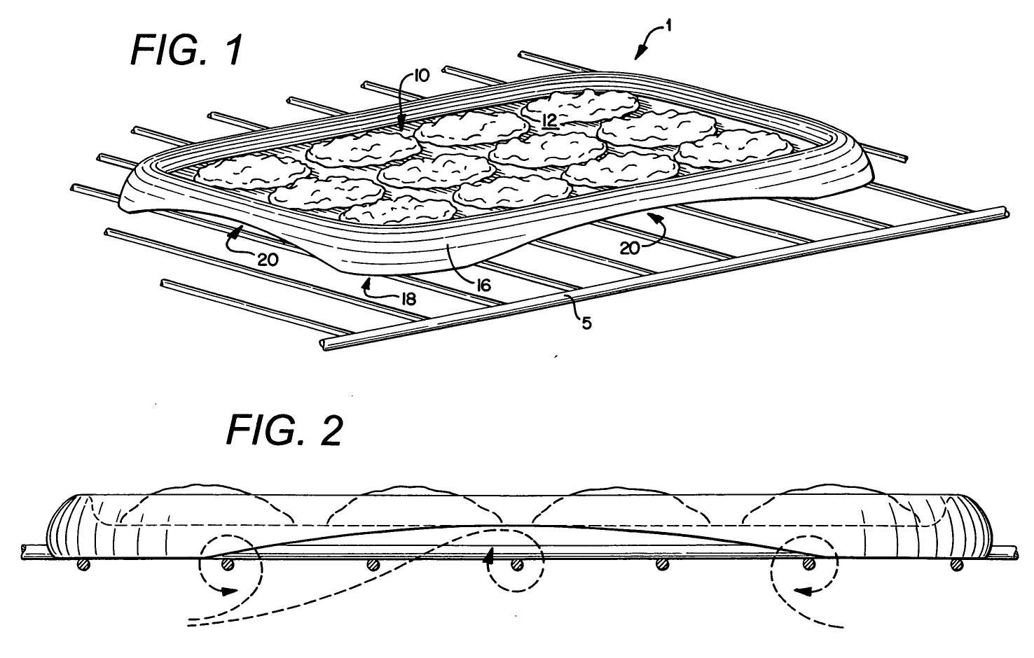

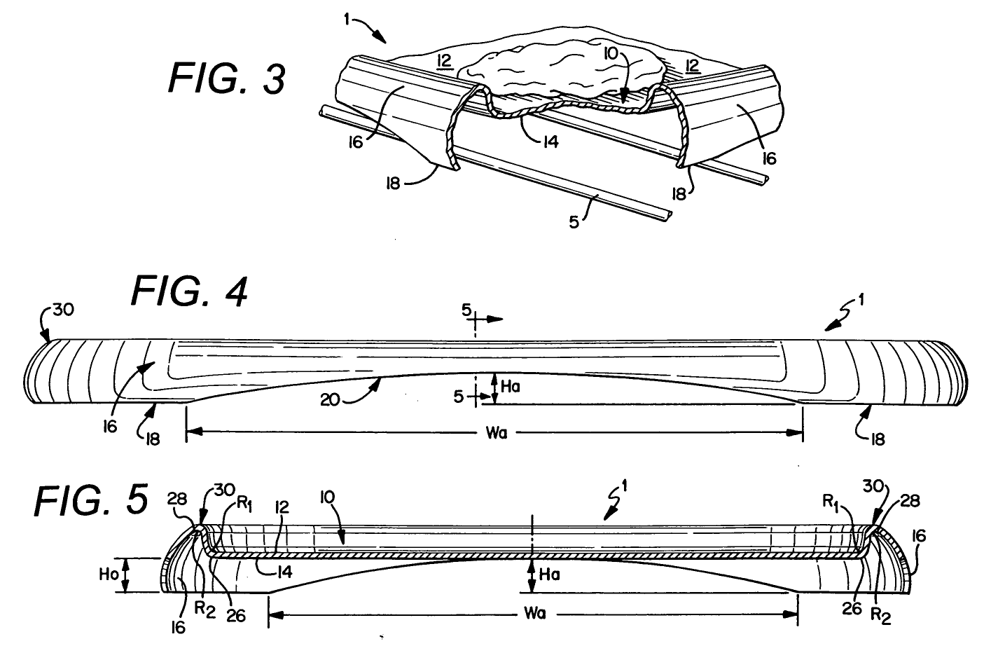

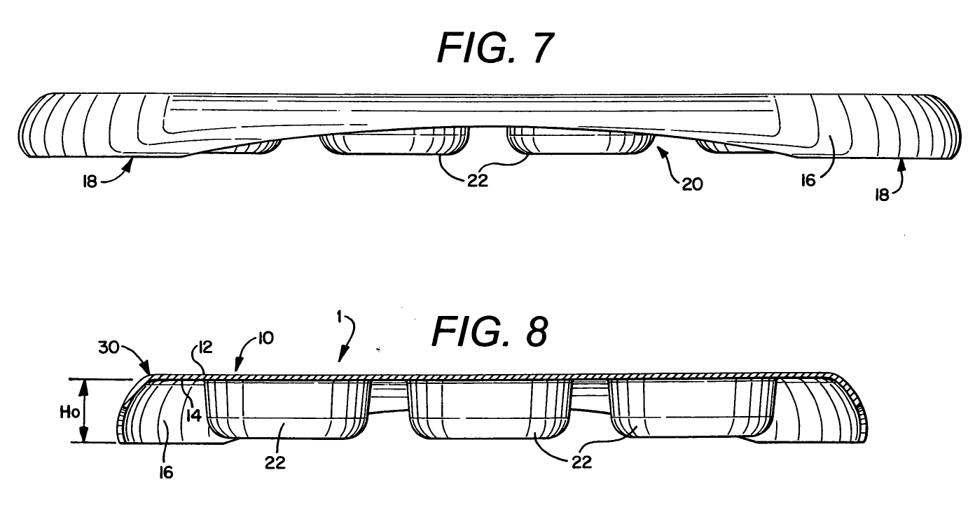

Referring now in detail to FIGS. 1-11, there is shown a heat-moderating baking pan 1 according to the present invention. Generally, the baking pan 1 includes a baking surface 10 having a top surface 12 and a bottom surface 14. Preferably, the baking surface 10 has a thickness Tₒ in the range of approximately 0.01 to 0.3 inches. However, it is contemplated that a baking surface 10 of any thickness Tₒ suitable for baking applications can be used in connection with the present invention.

It will be recognized by one skilled in the art that it is desirable to form the baking surface 10 from metal which has sufficient strength to support the baking pan 1, as well as the load of the food item to be baked on baking pan 1. For example, it is contemplated that the baking pan 1 of the present invention may be formed of steel or aluminum. It is also contemplated, however, that the present invention may be employed in bakeware formed from silicone and other materials. For example, the present invention may be employed in any conventional metal, glass, ceramic or any other material appropriate for the system in use and the food to be baked

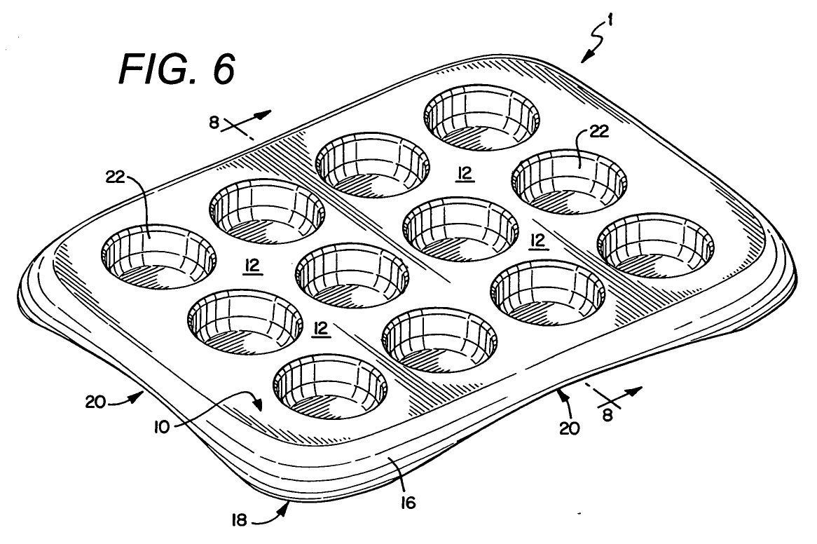

Furthermore, although the embodiments of the invention shown in FIGS. 1-11 depict the invention as being generally rectangular in shape, wherein the baking surface 10 has two opposed sides of a first length and the two other opposed sides of a second length, it is contemplated that other the pan may assume other geometric forms. For example, the baking pan 1 and/or its baking surface 10 my be circular, oval, square or any other geometric shape without departing from the present invention. Furthermore, the baking surface 10 may be generally smooth. Alternatively, the baking surface 10 can include undulations or dimples disposed therein. It is also contemplated that the baking pan 1 can include a plurality of baking wells 22 that extend downwardly from the baking surface 10 to define a baking well bottom 24 (FIGS. 6-8). These baking wells 22 can be used for baking muffins, small loafs or the like.

A sidewall 16 appends from the baking surface 10 to form at least a partial skirt-like structure. It will be understood that the sidewall 16 may be formed from a single, continuous member, or by several members appending from the baking surface 10. The sidewall 16 preferably extends downwardly and outwardly from the baking surface 10. However, it is also contemplated that the sidewall 16 can append at a 90° angle from the baking surface, or downwardly and inwardly from the baking surface 10 without departing from the present invention.

According to one embodiment of the invention, the top surface 12 of the baking surface 10 is disposed below an apex 30 of the sidewall 16. While any configuration suitable for creating this relative relationship may be employed, according to one embodiment shown in FIG. 5, the baking surface 10 can be connected to the sidewall 16 by a series of radii. More particularly, the baking pan 1 has a first radius R₁ defining a first connection portion 26 for connecting the baking surface 10 to the sidewall 16 and a second radius R₂ defining a second connection portion 28. The second connection portion 28 is disposed between, and integrally connected to (or formed with), the first connection portion 26 and the downwardly extending portion of the sidewall 16. The first connection portion 26 is disposed at a point above the terminal end of the sidewall 16 and peak of the second radius R₂ defines the apex of the sidewall 16. According to one embodiment of the invention, the first and second radii conform to the relationship R₂/R₁ being in the range of 0.5 to 8, and preferably in the range of approximately 0.01 to 2. It is also contemplated that the sidewall 16 be connected to the baking surface 10 via other configurations without departing from the present invention. For example, the sidewall 16 may append directly downwardly from the baking surface 10 or include an angular transition to the sidewall 16.

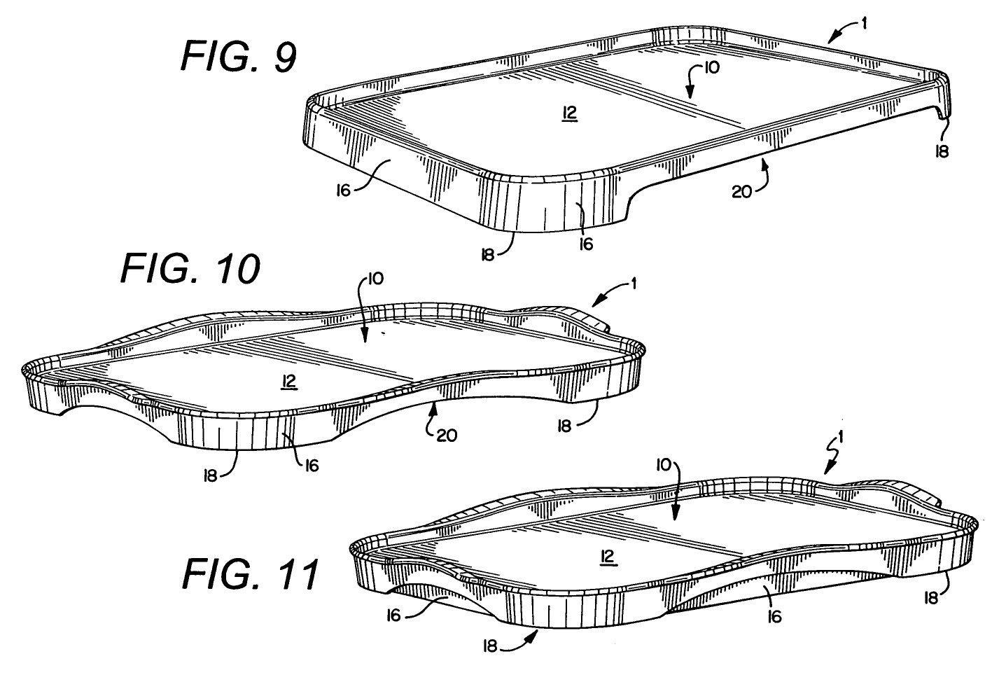

According to the present invention, the sidewall 16 terminates in a terminal edge 18 that is disposed at a position below the bottom surface 14 of the baking surface 10. In one preferred embodiment of the invention, the terminal edge 18 of the sidewall 16 or the terminal edge 18 members defining the sidewall 16 generally terminate at the same point. However, it is contemplated by the present invention that portions of the sidewall 16 or members defining the sidewall 16 have differing lengths. It is also contemplated that portions of the entire sidewall 16, or some of the members defining the sidewall 16, can have a terminal edge 18 that terminates above or at the bottom surface 14 of the baking pan 10. The distance between top surface 12 and the terminal edge 18 of the sidewalls 16 defines a cooking height Hₒ. The cooking height Hₒ is preferably in the range of approximately 0.25 to 3.0 inches. Most preferably, the cooking height Hₒ is in the range of approximately 0.4 to 2.0 inches, and especially 0.5 inches. However, it is contemplated that the cooking height Hₒ of the present invention be any height that elevates the cooking surface of the baking pan 1 above a cooking surface and which can conform to the relative relationships described herein. It will also be recognized that the terminal edge 18 can terminate in an abrupt extent as shown in FIGS. 1-8. Alternatively, as shown in FIG. 9, the terminal edge 18 can include a rim or lip extending outwardly from its margin to form a base for additional stability.

According to one embodiment of the present invention shown in FIGS. 1-10, the baking pan 1 also includes at least one aperture 20 in the sidewall 16. A portion of the aperture 20 is contiguous with a portion of the terminal edge 18 of the sidewall 16. It is believed that in such an embodiment, a single aperture 20 provides the optimal heat distribution across a defined baking surface area in a conventional oven; particularly when that aperture 20 is positioned to open to a back wall of the oven. However, it is contemplated by the present invention that any number of apertures 20 can be formed in the sidewall 16 of the baking pan 1. It is also contemplated that the aperture 20 or apertures in the sidewall 16 of the baking pan 1 may assume any geometric profile in which a portion of the configuration is contiguous with the terminal edge 18 of the sidewall 16. However, the aperture 20 is preferably a generally rectangular or arc-shaped cut-out in the sidewall 16 of the pan. It is also contemplated that, in one embodiment of the invention (not shown), no portion of the aperture 20 or apertures is contiguous with the terminal edge 18 of the sidewall 16.

As previously discussed, it has been determined that the height Hₐ and a width Wₐ of the apertures 20 influence the distribution of heat across the baking surface 10 of a baking pan 1. Preferably the height Hₐ of the aperture 20 will be in the range of approximately 0.25%-95% of the overall height of the sidewall 16, and the width Wₐ will be in the range of approximately 10%-90% of the overall width sidewall 16. Thus, according to the present invention, the upper most limits of at least one of the apertures 20 preferably conform to the relationship of Hₐ/Wₐ being in the range of approximately 0.01 to 2. More preferably, the relationship Hₐ/Wₐ conforms to the range of approximately 0.01 to 0.2. It will be recognized, however, that this relationship may vary with the overall dimensions of the baking pan 1, the cooking environment, and the materials from which the baking pan is formed.

While the specific embodiments have been illustrated and described, numerous modifications come to mind without significantly departing from the spirit of the invention, and the scope of protection is only limited by the scope of the accompanying Claims.

What is claimed is:

1. A baking pan comprising:
a baking surface having a top surface and a bottom surface;
a sidewall appending from the baking surface and terminating in a terminal edge, the terminal edge of the sidewall being disposed at a position below the bottom surface of the baking surface.

2. The baking pan of claim 1, further comprising a plurality of baking wells that extend downwardly from the baking surface to define a baking well bottom, the terminal edge of the sidewall being disposed at a position below the baking well bottom.

3. The baking pan of claim 1, wherein the top surface of the baking surface includes at least one of a plurality of undulations and a plurality of dimples disposed therein.

4. The baking pan of claim 1, wherein the top surface of the baking surface is disposed below an apex of the sidewall.

5. The baking pan of claim 4, further comprising a first radius R₁ defining a first connection portion for connecting the baking surface to the sidewall.

6. The baking pan of claim 5, a second radius R₂ defining a second connection portion, the second connection portion being integrally connected to the first connection portion and being disposed at a point above the terminal end of the sidewall.

7. The baking pan of claim 6, wherein the first and second radii conform to the relationship R₂/R₁ being in the range of approximately 0.5 to 8.

8. A baking pan comprising:
a baking surface having a top surface and a bottom surface;
a sidewall appending from the baking surface and terminating in a terminal edge, the terminal edge of the sidewall being disposed at a position below the bottom surface of the baking surface, the distance between top surface and the terminal edge of the sidewall defining a cooking height Hₒ; and
an aperture in the sidewall, a portion of the aperture being contiguous with a portion of the terminal edge of the sidewall and having a height Hₐ and a width Wₐ.

9. The baking pan of claim 8, wherein the cooking height Hₒ is in the range of approximately 0.25 to 3.0 inches.

10. The baking pan of claim 8, wherein the aperture conforms to the relationship Hₐ/Wₐ being in the range of approximately 0.01 to 2.

11. The baking pan of claim 10, wherein the aperture conforms to the relationship Hₐ/Wₐ being in the range of approximately 0.01 to 0.2.

12. The baking pan of claim 8, further comprising a plurality of baking wells that extend downwardly from the baking surface to define a baking well bottom, the terminal edge of the sidewall being disposed at a position below the baking well bottom.

13. The baking pan of claim 8, wherein the top surface of the baking surface is disposed below a top most point of the sidewall.

14. The baking pan of claim 13, further comprising a first radius R₁ defining a first connection portion for connecting the baking surface to the sidewall.

15. The baking pan of claim 14, a second radius R₂ defining a second connection portion, the second connection portion being integrally connected to the first connection portion and being disposed at a point above the terminal end of the sidewall.

16. The baking pan of claim 15, wherein the first and second radii conform to the relationship R₂/R₁ being in the range of approximately 0.5 to 8.

17. The baking pan of claim 8, wherein the sidewall extends downwardly and outwardly from the baking surface.

18. A baking pan comprising:
a baking surface having a top surface, a bottom surface and a thickness Tₒ in the range of approximately 0.01 to 0.3 inches;
a plurality of sidewall members defining a sidewall appending from the baking surface, each sidewall member terminating in a terminal edge, the terminal edge of at least two of the sidewall members being disposed at a position below the bottom surface of the baking surface, the distance between top surface and the terminal edge of the at least two sidewalls defining a cooking height Hₒ, the cooking height Hₒ being in the range of approximately 0.25 to 3.0 inches; and
an aperture in each of the at least two sidewalls, each aperture being contiguous with a portion of the terminal edge of the respective sidewall, the apertures each having a predetermined height Hₐ and a predetermined width Wₐ conforming to the relationship Hₐ/Wₐ being in the range of approximately 0.01 to 2.

19. The baking pan of claim 18, further comprising a plurality of baking wells that extend downwardly from the baking surface to define a baking well bottom.

20. The baking pan of claim 10, wherein at least one of the apertures conforms to the relationship Hₐ/Wₐ being in the range of approximately 0.01 to 0.2.
